(19) United States
(12) Patent Application Publication
(10) Pub. No.: US 2007/0293148 A1
(43) Pub. Date: Dec. 20, 2007

(54) Portable video communication device with multi-illumination source

(76) Inventor: Kuo Ching Chiang, Linkou Township (TW)

Correspondence Address: BIRCH STEWART KOLASCH & BIRCH, PO BOX 747, FALLS CHURCH, VA, 22040-0747, US

(21) Appl. No.: 11/812,031

(22) Filed: Jun. 14, 2007

Related U.S. Application Data
(63) Continuation-in-part of application No. 11/021,270, filed on Dec. 23, 2004.
(63) Continuation-in-part of application No. 11/120,005, filed on May 2, 2005.

(51) Int. Cl. H04H 7/00

(52) U.S. Cl. 455/3.06

(57) ABSTRACT

A portable device for video communication includes a control unit, a display coupled to the central control unit, respectively; a converter coupled to the central control unit; a vocal I/O unit coupled to the converter; an image capture module coupled to the control unit; a video communication module coupled to the control unit to facility video communication; and an image division module coupled to the control unit to divide displaying areas on the display when receiving multi-images from multi-parties during multi-parties video communication.

### FIELD OF INVENTION

The present invention relates to a portable device, particularly to a portable device having multi-illumination sources for video communication.

### BACKGROUND OF INVENTION

Because of the development of the information technology (IT), the information could be exchanged with higher capacity and faster speed. Internet is designed as an open structure to exchange information freely without restriction. The third generation mobile phone standard allows the user access video communication through air. Thus, certain communication service requiring real time information exchange, such as viewing a live video, has become feasible through mobile phone communication network or Internet.

### SUMMARY OF THE INVENTION

The present invention provides a system for synchronously communication via internet comprising a local area network and a terminal is coupled to the internet; a portable device with dual network linking capability module is used to transmit information through a RF module or the wireless local area network (WLAN) module, wherein the portable device includes an internet phone module and the WLAN module to allow a user may synchronously transmit or receive data through the internet, portably, wherein the transmitted information is selected from audio signal, video signal and the combination thereof. The terminal can be a computer, a personal digital assistant (PDA), a notebook, cellular or a smart phone, which is able to access the internet network via the local area network. The system further comprises a mobile phone communication service network. The system further comprises an exchanging service mechanism bridging the internet and the mobile phone network to facilitate the communication there between. The system may further comprise a public switch telephone network (PSTN).

The present invention provides a portable device for synchronously communication via internet comprising: a central control unit, an operation panel, a display, an operation system and memory coupled to the central control unit, respectively; a RF module that is compatible to a mobile phone communication protocol; a wireless local area network (WLAN) module that is compatible to a local area network protocol; CODEC and A/D converter are coupled to the WLAN module and the RF module; a vocal I/O unit is coupled to the A/D converter; and an Internet phone module is introduced, the Internet phone module accompany with the WLAN module allow a user may synchronously transmit or receive data through Internet by the wireless local area network module, portably, wherein the data is selected from the group consisting of audio signal, video signal and the combination thereof. The WLAN module includes Bluetooth standard compatible module, Wi-Fi standard compatible module or 802.11x standard compatible module, wherein the x can be a, b, or g. The wireless local area network (WLAN) module could be compatible to the WiMAX (Worldwide Interoperability for Microwave Access) standard.

The present invention provides a portable device with dual network linking capability module to transmit or receive information through a mobile phone communication service network or the Internet, wherein the portable device includes an Internet phone module and the WLAN module to allow a user may synchronously transmit or receive data through the local area network, portably, wherein the data is selected from audio, video and the combination thereof.

The portable device with dual communication mode for video communication includes a control unit, a display coupled to the central control unit, respectively; a converter coupled to the central control unit; a vocal I/O unit coupled to the converter; a wireless local area network (WLAN) module for coupling to a wired network hot spot; and a wireless video communication module coupled to the control unit to facility wireless video communication.

A portable device for video communication comprises a control unit, a display coupled to the central control unit, respectively; a converter coupled to the central control unit; a vocal I/O unit coupled to the converter; an image capture module coupled to the control unit; a video communication module coupled to the control unit to facility video communication; and an image division module coupled to the control unit to divide displaying areas on the display when receiving multi-images from multi-parties during multi-parties video communication.

### BRIEF DESCRIPTION OF THE DRAWING

For a better understanding of the present invention and to show how it may be implemented, reference will now be made to the following drawings:

FIG. 1 is a block diagram showing the device of the present invention.

FIG. 2 is a block diagram showing one embodiment of the device of the present invention.

FIG. 3 is a block diagram showing one embodiment of the device of the present invention.

FIG. 4 is a block diagram showing one embodiment of the device of the present invention.

FIG. 5 is a block diagram showing one embodiment of the device of the present invention.

### DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments.

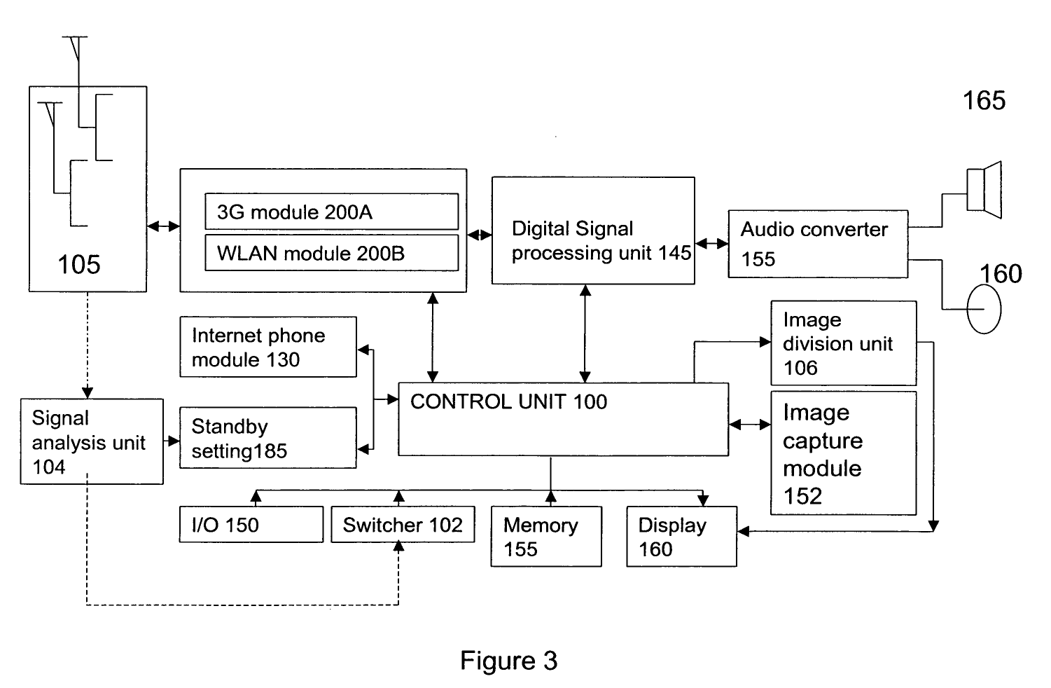

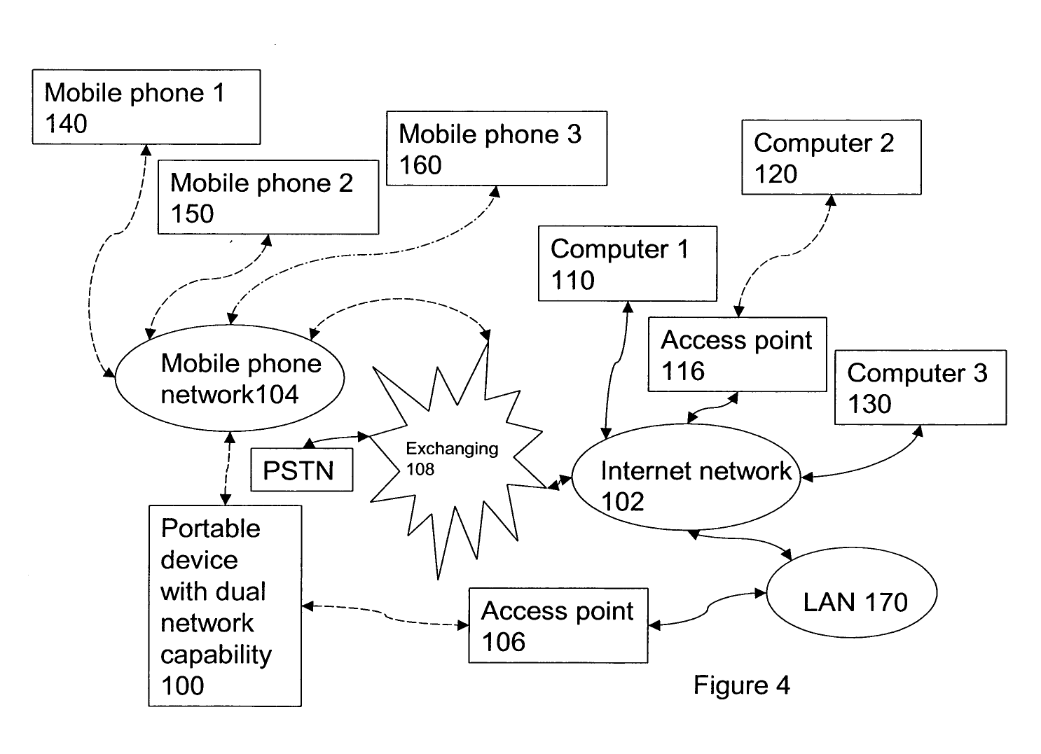

In FIG. 4, the system includes at least two different communication networks including a mobile phone network 104 such as a W-CDMA, CDMA2000, CDMA2001, TD-CDMA, TD-SCDMA UWC-136, DECT, 4 G communication service network and a local area network (LAN) 170 is coupled to an Internet 102. It should be noted that the LAN 170 is optional. There are pluralities of terminals of the users in FIG. 3. For example, the terminals (mobile phone) 140, 150 and 160 of the users are coupled to the mobile phone communication service network 104. Similarly, computers 110, 120, and 130 are coupled to the Internet 102, respectively. In one case, computers 110 and 130 are wired to the Internet 102 while the computer 120 is wirelessly coupled to the Internet 102 through the access point 116. It should be noted that the number of the terminals can be changed, and the present invention would encompass any possible number of the terminals. As we can see, computers are all coupled to Internet network 102, and the computer could be replaced by the terminals including but not limited to the PDA, notebook, cellular or the smart phone, which are able to access the Internet 102. The data exchange between them could be implemented directly through Internet 102.

The terminals 140, 150 and 160 and terminals 110, 120 and 130, for instance, are situated in different networks, which are Internet 102 and mobile phone network 104. The two types of terminals therefore could not communicate with each other directly. According to the preferred embodiment of the present invention, an exchanging service mechanism 108 bridging the two different networks is provided to facilitate the communication between terminals in the two networks. Namely, the exchanging service mechanism 108 is able to relay and link services between systems or networks.

An access point (or hot spot) 106 or 116 is coupled to the internet network to provide the entry to the local area network for wireless communication. One aspect of the present invention is that the system includes a portable device with dual network capability 100. It means that the device 100 may transmit and receive information through the mobile phone network or the Internet. The transmitted or the received information includes audio signal, video signal or both.

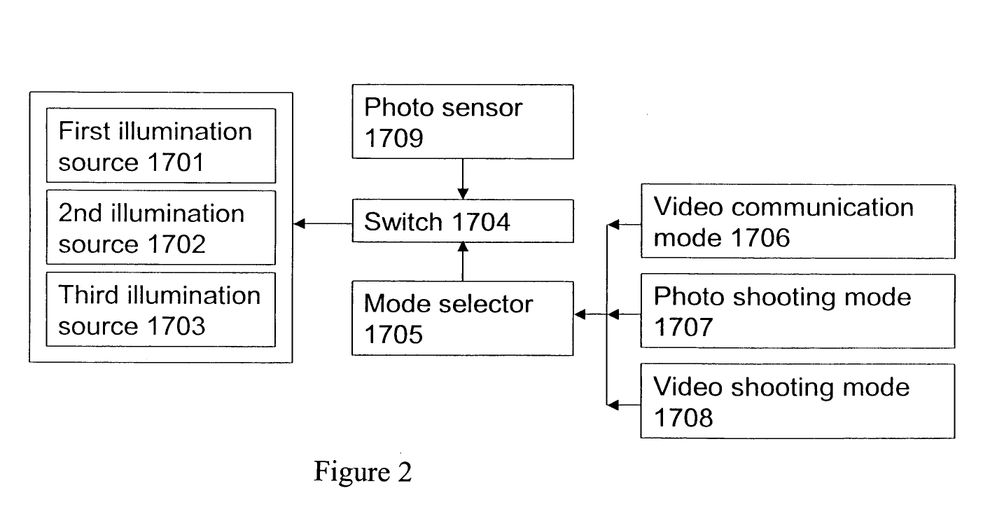

Referring to FIG. 2, it illustrates the functional diagram of the portable device 10 with dual networks capability. The dual way portable terminal 10 with SIM card connector to carry the SIM card, it is well know in the art, the SIM card is not necessary for some other type of cellular such as PHS or some CDMA system. The diagram is used for illustrating and not used for limiting the scope of the present invention. The portable terminal or device 10 includes a first and a second wireless data transferring modules 200A, 200B. The first wireless data transferring module 200A could be video RF module to transmit or receive mobile phone signal and it is well know in the art. As know in the art, the RF unit is coupled to an antenna system 105. The RF module may include base band processor and so on. This antenna is connected to a transceiver, which is used to receive and transmit signal. The first wireless data transferring modules 200A is compatible to the mobile phone protocol such as W-CDMA CDMA2000 CDMA2001 TD-CDMA TD-SCDMA, UWC-136, DECT, 4G system. There systems allow the user communicates with video communication. The RF module may perform the function of signal transmitting and receiving, frequency synthesizing, base-band processing and digital signal processing. The SIM card hardware interface is used for receiving a SIM card. Finally, the signal is send to the final actuators, i.e. a vocal I/O unit 153 including loudspeaker and a microphone. The module 200A, 200B can be formed by separated module (chip) or integrated chip.

The device 10 may include DSP 120, CODEC (not shown) and A/D converter 125 as well. The present invention includes a central control unit 100, a wired input/output) 150, a build-in display 160, OS (operation system) 145 and memory 155 including a ROM program memory, a RAM memory and a nonvolatile FLASH memory. All of the units mentioned above are coupled to the central control unit 100, respectively. The memory could be micro-type hard disc. The wired I/O interface 150 is coupled to the central control unit 100. The wired I/O interface could be USB, IEEE1394.

The device 10 further includes the second wireless data transferring modules 200B. In one embodiment, a wireless local area network (WLAN) module is employed and it could be compatible to the local area network protocol or standard such as Bluetooth standard, Wi-Fi standard, or 802.11x (x refers to a, b, g, n) standard compatible module. Further, the wireless local area network (WLAN) module could be compatible to the WiMAX (Worldwide Interoperability for Microwave Access) standard or specification. An Internet phone module 130 are coupled to the central control unit 100 to allow transmit and receive the audio, video or both type signal to/from the internet network through the wireless local area wireless transmission module. Internet phone module 130 at least meets the standard of Voice Over Internet Protocol (VoIP). By virtual of the Internet phone module 130 and the wireless local area network module 200B, the user may portably, synchronously transmit and receive the vocal, video or both signal through the internet by using the internet (software) phone module 130. An image capturing module 152 is required and coupled to the central control unit 100 to catch the video image if the user would like to conduct the real-time video transmission. The image capturing module 152 could be digital still camera, digital video camera. Therefore, the real-time portable conference is possible. In another embodiment, the one difference is that the device may omit the RF module. If the device 10 includes 3G or higher level RF module, the user may transmit the video phone through the air. Therefore, the user may select one of the schemes to make a video call through internet or air depending on the user demand. If the device is within the hot spot area, the user may choose the usage of the internet phone module for communication due to cheaper transmitting fee. If the out of the hot spot range, the other option for video communication is provided. Typically, the WCDMA signal is less restricted by the geography limitation, but the transmission fee is higher. The present invention allows the user selecting the proper wireless module for video communication. If the user would like to conduct the video communication through WiFi or WiMax, the method includes coupling to internet or hot spot, followed by active the internet (software) phone module. Subsequently, vocal signal is input from the speaker and image data is captured from the image capture device, subsequently, the image data and the vocal signal are converted from signal to digital. After the conversion, the image data and the vocal signal are composition, compressed or processed to form a data streams. Therefore, the data may be transmitted to the receiving party seriously. BER of less than about 10.sup.−5 at the channel decoder output is considered desirable for digital music and video transmissions. The bits in a given source coded bit stream (e.g., a compressed audio, image or video bit stream) often have different levels of importance in terms of their impact on reconstructed signal quality. As a result, it is generally desirable to provide different levels of channel error protection for different portions of the source coded bit stream. Techniques for use in providing such unequal error protection (UEP) through the use of different channel codes are described in U.S. patent application Ser. No. 09/022,114, filed Feb. 11, 1998, and entitled “Unequal Error Protection for Perceptual Audio Coders,”. A source coded bit stream is divided into different classes of bits, with different levels of error protection being provided for the different classes of bits.

One aspect of the present invention is that the present invention provides single or multi-illumination sources module 170 coupled to the control unit 100 for video communication during darkness or low light environment. Thus, a selection interface 172 is coupled to the multi-illumination sources module 170 for selecting the mode. FIG. 2 shows the multi-illumination sources module 170 which includes a first illumination source 1701, a second illumination source 1701 and maybe a third illumination source 1701. The number of the light source is optional. A photo sensor 1709 is coupled to a switch 1704 coupled to the multi-illumination sources module 170. When, the light intensity is lower than a predetermined level, the control unit is in responsive to the signal detected by the photo sensor 1709 to active the illumination to provide light for video communication or photo taking. One mode of the illumination sources maybe night vision mode such as IR. It may support the video communication 1706 or video photo shooting (1708) at dark environment. A further mode could be a flash mode 1707 in order to provide a flashing light for low-light intensity photo taking. The user may select the mode through the mode selector 1705 coupled to the switch 1704. The illumination module includes IR device, LED that emits white light. Further, the illumination module includes Xeon gas lighting device. Gas is supplied to the discharge region to replace the vast majority of the air during charge particle generation. The gas is a mixture consisting essentially of nitrogen with an amount of argon, neon, xeon, or krypton effective to provide a catalyst for nitrogen ionization. The user may select proper illumination for different purpose at different situation. Specially, the present invention may execute the video communication at dark environment.

The system of FIG. 4 may couple to PSTN for linking to the home telephone system. The service relay may connect to the telephone with the link information through Internet. It should be appreciated that the device types of terminals could be varied depending on the support of available networks. The present invention would encompass possible communication devices with the ability to access the various networks.

The device may couple to the internet via the wired data I/O interface or the WLAN module 200 B to upload or download data including digital data such as text format, image format, audio signal, video signal. The wired data I/O interface 150 is coupled to the central control unit 100. The application of the apparatus is quite economical and convenience. Moreover, the user may call other one by the internet phone module to reduce the transmission fee when the local area wireless transmission module 240 detects the signal of the internet network. Otherwise, the user may use the WCDMA for video communication. The portable real-time video conference is possible by implementation of the present invention. Further, the present invention provides dual modes (3G or internet video phone) portable audio/video communication, synchronously.

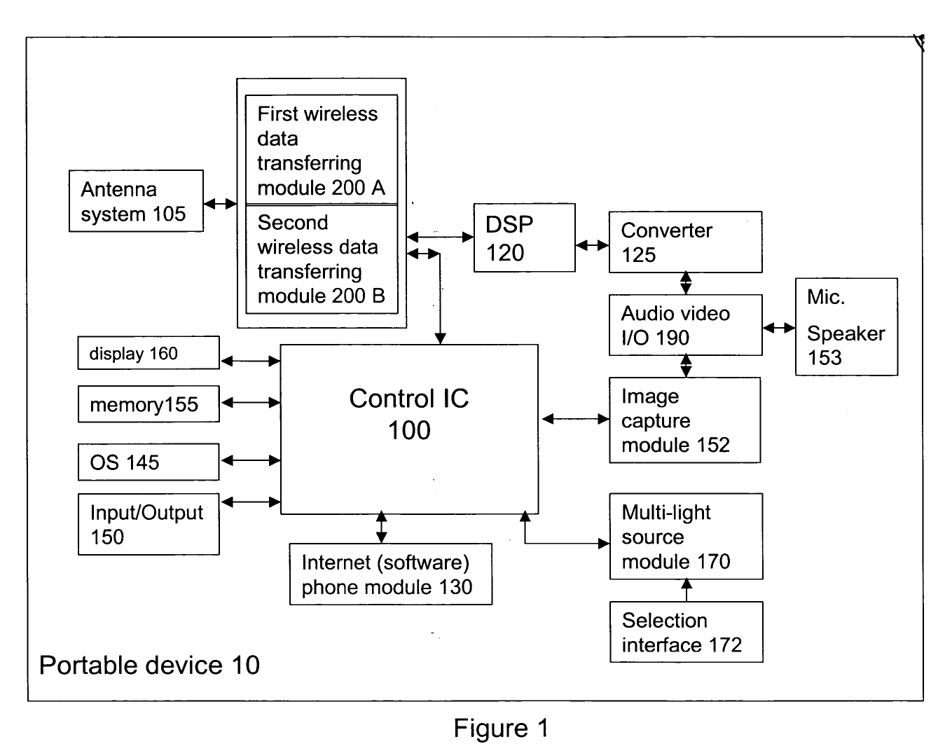

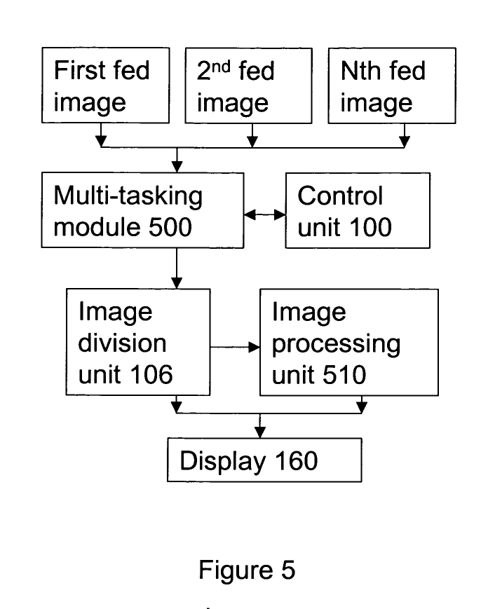

FIG. 3 illustrate alternative embodiment of the present invention, almost of the elements are similar to FIG. 1, the detailed description is omitted. A signal analysis 102 is provided to analysis the signal strength of the dual communication module 200A, 200B. The result will be fed into the module switch 102 to automatically to switch the module or set by manual through the standby setting interface 185. In order to implant the multi-parties video communication, the device 10 includes an image division unit 106 coupled to the control unit 10 to division the displaying area on the display to display the received images synchronicity. The method of display division may refer to U.S. Pat. Nos. 7,171,019, 7,142,689, assigned to Canon Kabushiki Kaisha (Tokyo, JP), U.S. Pat. No. 7,059,729, assigned to Hitachi, Ltd. (Tokyo, JP). Therefore, multi-parties video communication is achieved. The received images will be assigned to the divided displaying area on the display and the displaying areas may be separated, overlap or partial overlap. Please turning to FIG. 5, a plurality of fed images is transmitted to the multitasking module 500 for processing the received images from multi-parties. The images will be processed by the image division unit 106 before sending the image data signals to the display 160. Image processing unit 510 maybe employed to adjust the processed image before displaying.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A portable device with dual communication mode for video communication, comprising:
a control unit,
a display coupled to said control unit, respectively;
a converter coupled to said control unit to convert signal between digital and analog;
a vocal I/O unit coupled to said converter;
a wireless local area network (WLAN) module for coupling to a hot spot; and
a wireless video communication module coupled to said control unit for wireless transmitting video data for video communication.

2. The portable device as set forth in claim 1, further includes a software phone module coupled to said control unit to transmit or receive data through said wireless local area network (WLAN) module.

3. The portable device as set forth in claim 1, wherein said wireless local area network (WLAN) module includes Wi-Fi module.

4. The portable device as set forth in claim 1, wherein said wireless local area network (WLAN) module includes 802.11 module.

5. The portable device as set forth in claim 1, wherein said wireless local area network (WLAN) module includes WiMAX (Worldwide Interoperability for Microwave Access) module.

6. The portable device as set forth in claim 1, wherein said wireless video communication module includes W-CDMA, CDMA2000 CDMA2001 TD-CDMA TD-SCDMA UWC-136 DECT or 4G module.

7. A portable device for video communication comprising:
a control unit,
a display coupled to said central control unit, respectively;
a converter coupled to said central control unit;
a vocal I/O unit coupled to said converter;
an image capture module coupled to said control unit;
a video communication module coupled to said control unit to facility video communication; and
an image division module coupled to said control unit to divide displaying areas on said display when receiving multi-images from multi-parties during multi-parties video communication.

8. The portable device as set forth in claim 7, wherein said video communication module includes W-CDMA, CDMA2000, CDMA2001, TD-CDMA, TD-SCDMA, UWC-136, DECT or 4G module.

9. The portable device as set forth in claim 7, wherein said video communication module includes software phone module.

10. The portable device as set forth in claim 9, further includes a wireless local area network (WLAN) module.

11. A portable device for video communication comprising:
a control unit,
a display coupled to said control unit, respectively;
a converter coupled to said control unit;
a vocal I/O unit coupled to said converter;
an image capture module coupled to said control unit;
a video communication module coupled to said control unit to facility video communication; and
an illumination module coupled to said control unit to provide illumination during video communication, video or photo shooting.

12. The portable device as set forth in claim 11, wherein said illumination module includes multi-light sources.

13. The portable device as set forth in claim 11, wherein said illumination module includes IR device.

14. The portable device as set forth in claim 11, wherein said illumination module includes LED.

15. The portable device as set forth in claim 11, wherein said illumination module includes Xeon gas lighting device.
